(19) United States
(12) Patent Application Publication
(10) Pub. No.: US 2007/0057921 A1
(43) Pub. Date: Mar. 15, 2007

(54) Standardized/extensible semantics in device independent navigation shortcuts in an application

(76) Inventors: Phillip D. Jenkins, Cedar Park, TX (US); Aaron M. Leventhal, Arlington, MA (US); Richard Schwerdtfeger, Round Rock, TX (US)

Correspondence Address: Greg Goshorn, P.C., 9600 Escarpment, auite 745-9, AUSTIN, TX, 78749, US

(21) Appl. No.: 11/082,701

(22) Filed: Mar. 17, 2005

(51) Int. Cl. G09G 5/00; G06F 17/00; G06F 3/00; G06F 9/00

(52) U.S. Cl. 345/172; 715/827; 715/847; 715/854; 715/831

(57) ABSTRACT

Provided is a method for assigning navigation shortcuts to computing elements in a manner that is not browser, platform or computing device specific and may, if desired, take into consideration an application, document landmark, document type, or genre. A user agent or application reserves a predefined set of access keys to represent typical navigation landmarks. Using these predefined access keys, an author and/or portal designer maps the predefined access keys to browser key equivalents, thus providing consistent navigation across an application or portal. Documents may also include predefined “genres.” An author designates a genre to the document, requests device access keys from the platform, assigns functions corresponding to the designated genre to each access key and then displays the assignments and descriptions to the user of the browser or application. Thus navigation across particular documents, document sections, and web sites within a genre is standardized.

### TECHNICAL FIELD

The present invention relates generally to computer input mapping and, more specifically, to a method of dynamically assigning a standardized set of access keys based upon application type and other criteria.

### SUMMARY OF THE INVENTION

Provided is a method for assigning navigation shortcuts, i.e. sequences of input or mnemonic attributes, to computing elements such as, but not limited to documents and web pages, on a computing device in a manner that is not browser, platform or computing device specific and may, if desired, take into consideration an application or document type, or genre.

A platform or computing device reserves a set of device dependent mechanisms, or “access keys,” that may be assigned to browser or application defined functionality to create navigation short cuts. A user agent or application reserves a predefined set of access keys to represent typical navigation landmarks such as, but not limited to, moving focus to a banner, navigation bar, footer and one or more portals. In addition, predefined access keys may also be reserved for such navigation actions as “back” and “forward.” By employing these predefined access keys, an author and/or portal designer can map the predefined access keys to browser key equivalents on every page of a website without knowing browser-specific key combinations, thus providing consistent navigation across an application, portal, or any web site for which an author uses the standard access keys.

Further, documents or pages displayed by the browser may include predefined genres. Examples of genres include, but are not limited to, banking, health care, finance, weather, news, and so on. The author of the document or page designates a specific genre corresponding to the document or page. When the document or page is loaded, the device access keys are requested from the platform. The platform then dynamically assigns each function associated with the designated genre to an access key and provides a display to show the assignments and descriptions associated with the dynamically created shortcuts to the user of the browser or application. In this manner, navigation across particular genre applications and pages can be standardized.

The application or browser that assigns key combination, or mnemonic attributes, provides, upon initiation, a list of the assigned mnemonic attributes and their corresponding functionality in the form of a description. Further, if the same access key is assigned to different functionalities within different applications of an application and a browser, the meaning of the mnemonic attribute associated with the access key is determined by its context. Since the number of available keys is limited based on device, browser, and operating system, the claimed subject matter enables keys to be re-used based on their semantic context.

The claimed subject matter enables a developer to provide, across an application or portal and within particular application genres, standardized navigation shortcuts that are device and browser independent. For example, applications that enable a user to trade stocks or view stock prices via web pages may have one particular interface and word processing programs and other applications that enable a user to manipulate figures and/or documents may have another standardized interface, both of which are browser and platform independent. Additionally, the claimed subject matter allows for a consistent user experience across similar web sites having similar applications involving like genres and short cuts using the same browser.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary computing system architecture that supports the claimed subject matter.

FIG. 2 is an illustration of a keyboard, first introduced in FIG. 1.

FIG. 3 is an application window that might be viewed in the display introduced in FIG. 1.

FIG. 4 is a flowchart of an exemplary process for setting up the claimed subject matter on a computing device.

FIG. 5 is a flowchart of an exemplary process for the operation of the claimed subject matter.

FIG. 6 is the application window of FIG. 3 showing a Hot Key Assignment List corresponding to the displayed application.

FIG. 7 is a flowchart of an exemplary process for setting up a genre specific implementation of the claimed subject matter.

FIG. 8 is an application window similar to the application window of FIG. 3 showing a Hot Key Assignment List corresponding to a second displayed application.

### DETAILED DESCRIPTION OF THE FIGURES

Although described with particular reference to a desktop computer and a hand-held computing device, the claimed subject matter can be implemented in any information technology (IT) system in which input/out (I/O), or “navigation,” shortcuts are desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

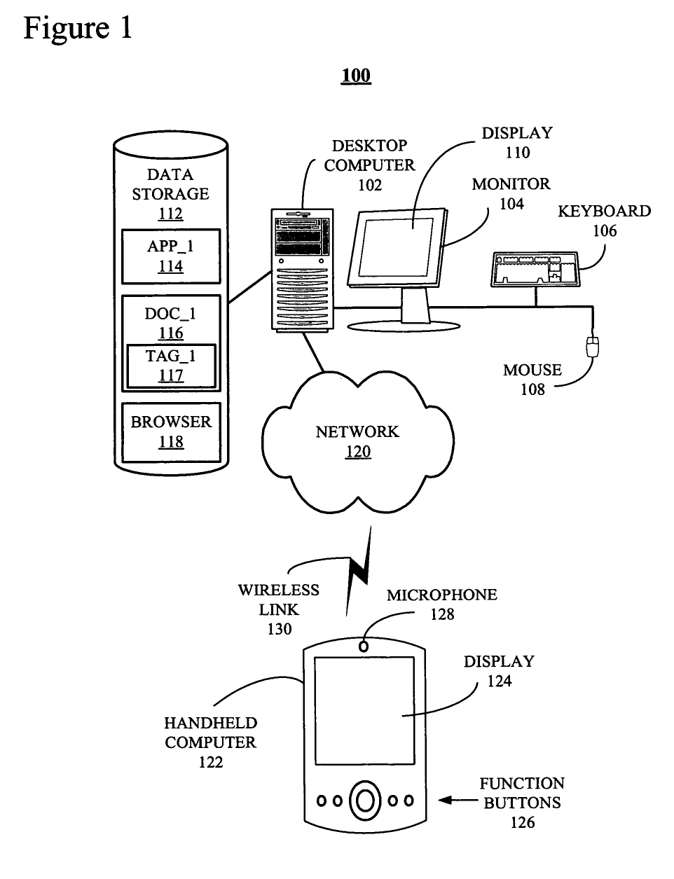

Turning now to the figures, FIG. 1 is a block diagram illustrating exemplary computing system architecture 100 that supports multiple devices that employ the claimed subject matter. A desktop computer 102 includes a monitor 104, a keyboard 106 and a mouse 108. Monitor 104 includes a display 110. Monitor 104, keyboard 106, mouse 108 and display 110 facilitate human interaction with computer 102.

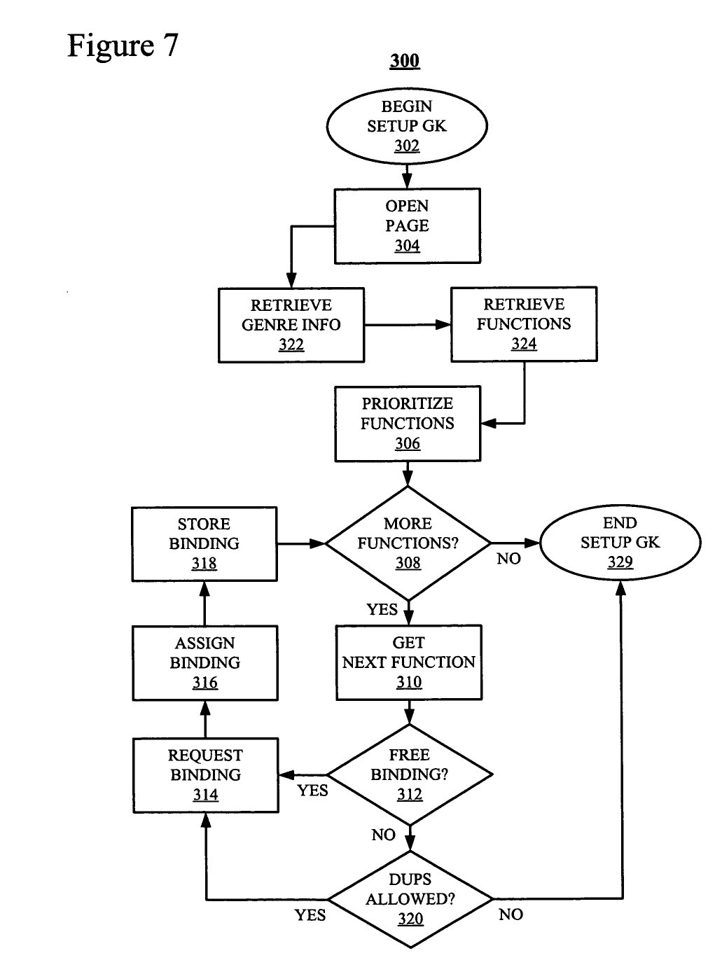

Attached to computer 102 is a data storage component 112, which may either be incorporated into computer 102 i.e. an internal device, or attached externally to computer 102 by means of various, commonly available connection devices such as but not limited to, a universal serial bus (USB) port (not shown). In this example, data storage 112 stores two (2) exemplary applications, an app_{—}1 114 and a web browser program 118, and one (1) document, a doc_{—}1 116. Doc_{—}1 116 includes an identifying tag, a tag_{—}1 117, both of which are explained in more detail below in conjunction with FIG. 7.

In the following examples, app_{—}1 114 is a word processing program, although the claimed subject matter is equally applicable to almost any type of application. Browser 118 is Internet Explorer by Microsoft, although the claimed subject matter is equally applicable to any web browser. In fact, the claimed subject matter is equally applicable to animation applications such as flash, portable document format (PDF) and other applications that can run arbitrary content, such as, but not limited to, MS Word and Excel (macros) by Microsoft and many database clients.

Also illustrated is handheld computer, also referred to as a personal digital assistant (PDA), 122, which includes a display 124, function buttons 126 and a microphone 128. Display 124, function buttons 126 and microphone 128 facilitate human interaction with PDA 122.

Computer 102 and PDA 122 are each communicatively coupled a network 120. Computer 102 is connected to network 120 via a wired connection and PDA 122 is connected via a wireless link 130. Network can be any type of network such as, but not limited to, a local area network (LAN) or the Internet. Although not shown, computing system is managed by an operating system (OS), which can be any available operating system.

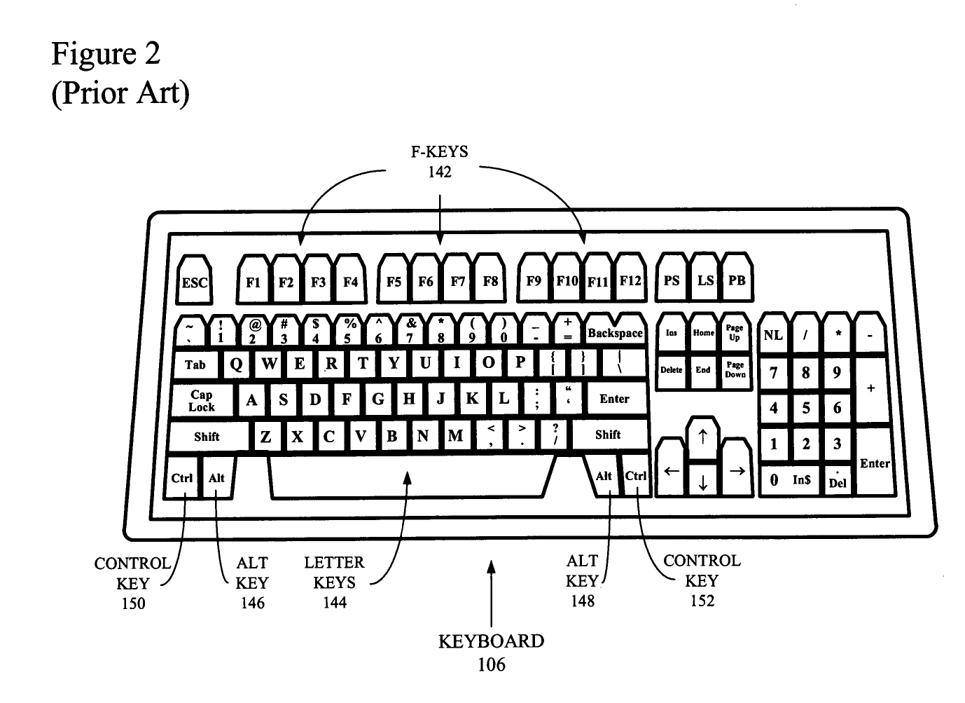

FIG. 2 is an illustration of a typical computer keyboard 106 first introduced above in conjunction with FIG. 1. Keyboard 106 should be familiar to anyone with experience with computers, such as desktop computer 102. Among the many types of keys, keyboard 106 includes function keys, or “F-keys,” 142, letter keys 144, “Alt” keys 146 and 148 and control keys 150 and 152. For the sake of simplicity, letter keys 144 are not individually number, but will be referred to by corresponding labels, such as the ‘F’, ‘E’, ‘P’, ‘T’ and ‘H’ letter keys 144. In the following figures, an example of the claimed subject matter is described with reference to keys 142, 144, 146, 148, 150 and 152. It should be noted that the claimed subject matter is equally applicable to the input/output (I/O) features of PDA 122 (FIG. 1), such as display 124 (FIG. 1), function buttons 126 (FIG. 1) and microphone 128 (FIG. 1).

Keyboard 106 is employed in the following examples to describe the claimed subject matter. Keyboard 106, as an input device for computer 102, has certain input sequences, or “access keys,” reserved for the dynamic assignment of applications such as app_{—}1 114 and browser 118. Information about specific access keys may be stored as part of a device driver (not shown) corresponding to a particular device. Typically, in computer 102, the device driver for keyboard 106 would be stored in data storage 112. With regard to a device such as PDA 122 (FIG. 1) access key information is stored in an internal memory (not shown) and would related to the particular input mechanisms available on PDA 122, e.g. function buttons 126 (FIG. 1).

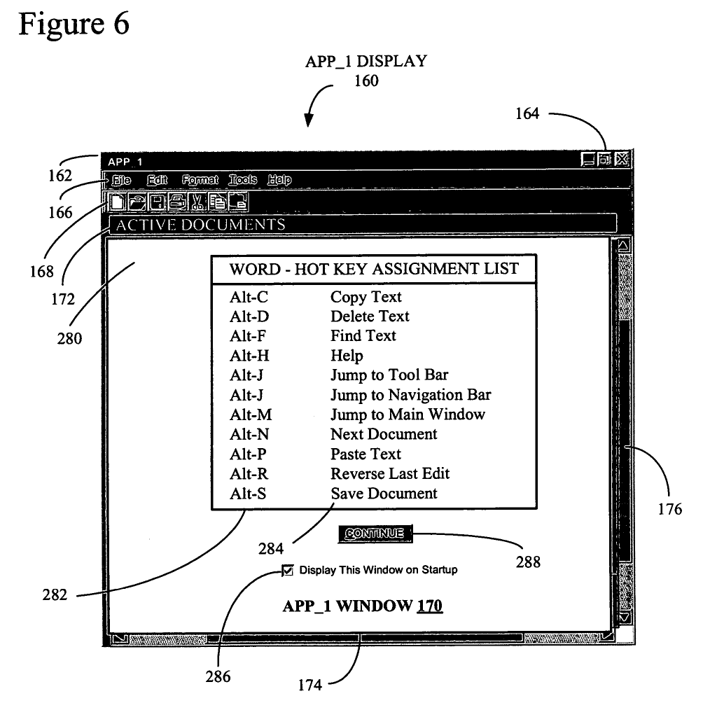

In the following examples, the “Alt-C,” “Alt-D,” “Alt-F,” “Alt-H,” “Alt-J,” “Alt-M,” “Alt-N,” “Alt-P,” “Alt-R” and “Alt-S” access keys are used to implement the claimed subject matter (see FIG. 6). It should be understood that these particular are used as examples only and there are many other input devices, keys and combinations of keys that may be employed as reserved access keys.

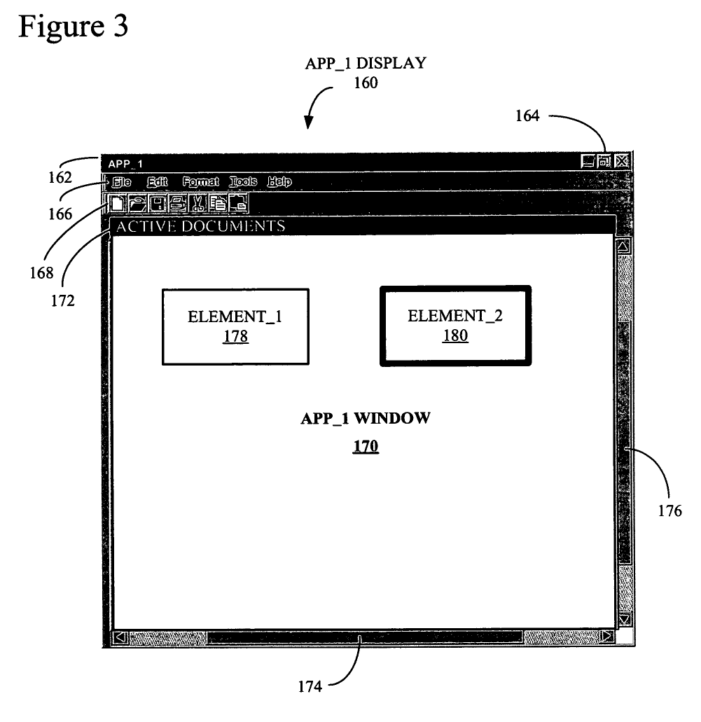

FIG. 3 is an illustration of an app_{—}1 display 160, as viewed in display 110 (FIG. 1) of computer 102 (FIG. 1). In this example, an app_{—}1 display 160 is displayed in conjunction with the execution of app_{—}1 114 (FIG. 1), which as explained above is a word processing program. A title bar 162 displays the name of the corresponding application, i.e. app_{—}1 114. Window control buttons 164 the operation of app_{—}1 display 160. Buttons 164 enable a user to minimize, maximize and close app_{—}1 display 160. Menu items 166 provide functionality associated app_{—}1 114. Menu items include a “File” menu option, an “Edit” menu option, a “Format” menu option, a “Tools” menu option and a “Help” menu option. Associated with each menu option is an input key combination or “hot key.” The specific hot key associated with each menu option can be determined by noting which letter in the menu option is underlined. For example, the File menu option is displayed as “File,” indicating that the letter ‘F’ is the corresponding hot key. Similarly, the Format menu option is displayed as “Format,” indicating that the letter ‘O’ is the corresponding hot key. These hot key assignments are active when the focus in app_{—}1 display 160 is on menu items 166 and are activated by pressing one of the Alt keys 146 or 148 (FIG. 2) and the corresponding letter key 144 (FIG. 2).

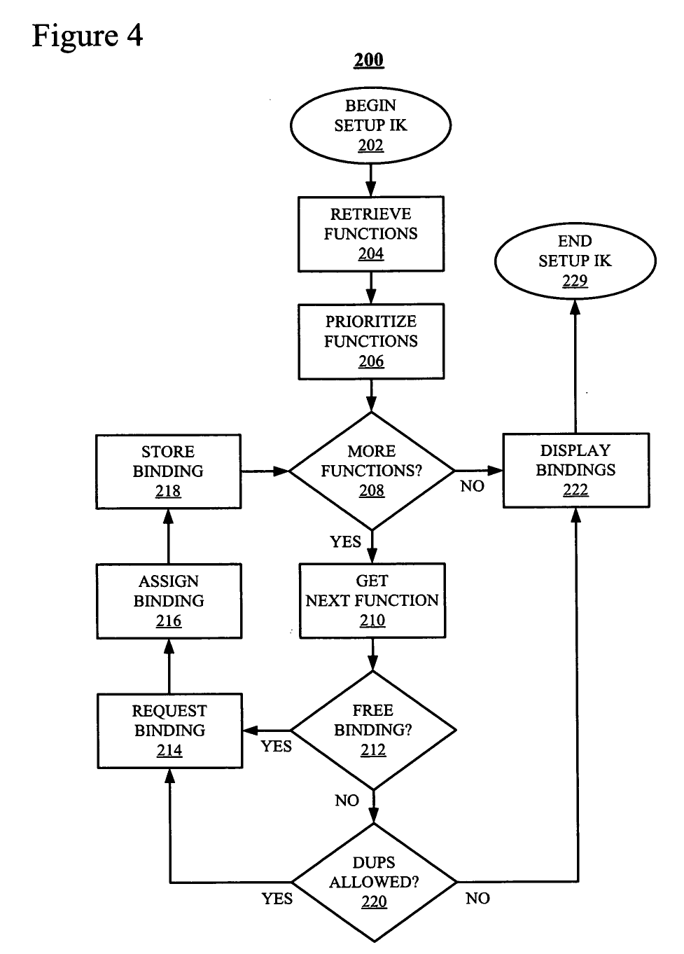

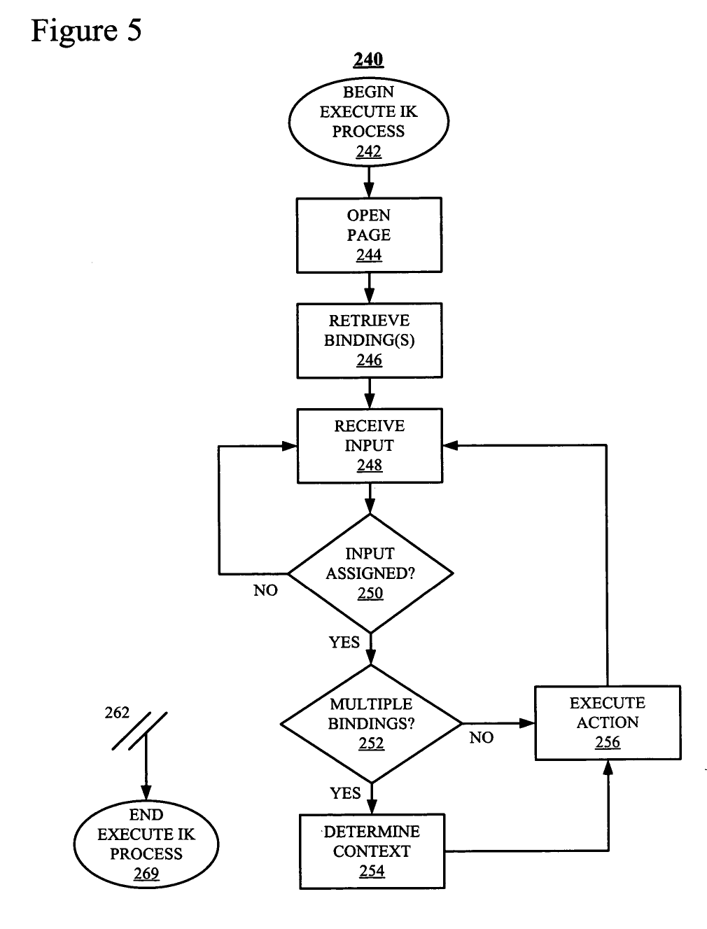

Some typical examples of input key combinations, or hot keys, are the pressing of an F-key 142 (FIG. 2), an alt key 146 or 148, or a control key 150 or 152 (FIG. 2) in conjunction with simultaneous pressing of a letter key 144. One example is the pressing of alt key 146 with ‘H’ letter key 144. This particular combination of keys is referred to throughout the rest of the specification as “Alt-H.” Control key 152 pressed in conjunction with ‘J’ letter key 144 is referred to as “Ctl-J.” Often, F-keys 142 are pressed individually rather than in conjunction with another key and are referred to as “F1,” “F2” and so on. Those with experience with typical computing device interfaces should be familiar with this “alt-letter,” “ctl-letter” and “F#” format. The configuration and use of hot keys in conjunction with the claimed subject matter is explained in more detail below in conjunction with FIGS. 4 and 5.

Below Menu buttons 166 are several Toolbar buttons 168, which provide a user of app_{—}1 114 with quick access to various features of app_{—}1 114. The buttons 168 in this example represent the operations of creating a new document, opening a new file, saving a file, cutting text in a document, copy text in a document and pasting text into a document. Those with experience with typical word processing applications should be familiar with Toolbar buttons 168.

An application window, or app_{—}1 window 170, is illustrated in the main area of app_{—}1 display 160. A title bar, or banner, 172 displays the name of app_{—}1 window 170, i.e. “Active Documents.” A horizontal slider bar 174 enables a user to reposition window 170 with respect to right and left. A vertical slider bar 176 enables a user to reposition window 170 with respect to up and down.

Within app_{—}1 window 172 are two open documents, or elements: an element_{—}1 178 and an element_{—}2 180. In this example, element_{—}2 is the active element in window 170, i.e. the element that is the focus of any input currently directed to app_{—}1 114 via window 170.

FIG. 4 is a flowchart of an exemplary “Setup Input Keys (IK)” process 200 that sets up the claimed subject matter on a computing device such as, but not limited to, desktop computer 102 (FIG. 1). Process 200 is described with respect to app_{—}1 114 although it should be understood that process 200 applies to practically any computer executed process and corresponding platform. In this example, process 200 is executing on computer 102 and is part of the OS, example of which include Windows, Solaris, published by Sun, Mac OS and Linux. In an alternative embodiment, process 200 is executed as part of browser 118 (FIG. 1) and applies only to applications executed via browser 118. Further, process 200 may be incorporated into many different execution contexts. As shall be evident, one of the advantages of the claimed subject matter is that it is both hardware and OS independent.

Process 200 starts in a “Begin Setup Input Keys (IK)” block 202. Throughout the remainder of the specification sequences of input keys corresponding to a particular device are referred to as “access keys.” Control proceeds immediately to a “Retrieve Functions” block 204 during which an application, in this example app_{—}1 114 (FIGS. 1 and 3), determines which particular functionality associated with app_{—}1 114 has been designated as a functionality that should be assigned to a reserved set of access keys.

It should be understood process 200 described in relation to a device such as desktop computer 102 (FIG. 1) and that the specific access keys depend upon the particular device that implements the claimed subject matter. For example, an access key may take the form of a click of mouse 108 (FIG. 1) while a cursor (not shown) is positioned at a particular location on display 110 (FIG. 1). On handheld computer 122 (FIG. 1) an access key may take the form of either one or more activation of a function button 126 (FIG. 1) or voice commands entered via microphone 128 if computer 122 is configured to operate in such a manner.

The designation of specific functionality that requires correlation with an access key is typically defines by a developer of the corresponding application, such as app_{—}1 114, and is specific to a particular application and/or industry for which the application is directed. For example, with respect to a word processor, access keys may be defined for functions such as those represented by toolbar buttons 168 (FIG. 3) With respect to particular industries, such as the financial industry, an industry can employ the claimed subject matter to define access keys that relate specifically to the trading of stocks, regardless of the particular application that is executing a trade. Further, access keys can be defined to have application-wide scope, such as an access key configured to enable a user to close app_{—}1 114 or to shift focus among elements of a particular window, e.g. from element_{—}2 180 (FIG. 3) to another element_{—}1 178 (FIG. 3) and vice versa. Other defined access keys may apply specifically to elements that have current focus. An example of some possible access key definitions corresponding to app_{—}1 114 are shown below in conjunction with FIG. 6.

During a “Prioritize Functions” block 206, process 200 orders the functions retrieved during block 204 according to information stored in conjunction with the functions. Additional information that may be stored in conjunction with the functions is a list of preferred bindings. During a “More Functions?” block 208, process determines whether or not there is an unassigned functions that needs to be bound to a platform-dependent access key. If so, control proceeds to a “Get Next Function” block 210 during which process 200 retrieves the next unassigned function. Since the list of functions was prioritized during block 206, the next function corresponds to the highest priority functions. In the alternative, during block 210, process may select the highest priority function from a list of unordered function, i.e. rather than executing Prioritize Functions block 206.

During a “Free Binding?” block 212, process 200 determines whether or not the operating system has an unassigned platform-dependent access key that can be associated with the function identified during block 210. If so, during a “Request Binding” block 214, process 200 requests from the OS one of the available platform-dependent access keys identified during block 212, taking into consideration any preferred bindings information that may be associated with the particular function.

If during “Free Binding?” block 212, process 200 determines that none of the platform-dependent access keys are unassigned, process 200 proceeds to an “Duplicates (“Dups”) Allowed?” block 220 during which process 200 determines whether or not the OS of computer 102 or browser 118, depending upon the entity executing process 200, is configured to allow more than one key sequence to be assigned to a particular access key. In the alternative, the allowance of duplicate bindings may be specified as part of the information associated with particular functions. In addition, bindings can be enabled or disables globally or on an element by element basis. In this example, duplicate bindings are globally enable or disabled, either by the platform or the application requesting the bindings. If duplicates are allowed, process 200 proceeds to Request Binding block 214 during which, as explained above, the OS or browser provides an access key for binding.

During an “Assign Binding” block 216, process 200 associates the current function identified during block 210 with the access keys identified during block 212 or 220 to create a navigation shortcut, or mnemonic attribute. In other words, the particular actions associated with the identified application functions are associated with the corresponding access keys reserved by the corresponding device. One example of programming code the could be employed in an Extensible Markup Language based (XML-based) application such as Extensible Hypertext Markup Language (XHTML) is as follows:

<element accesskey = true description = ”Racing Results”>
<accesskey id = “mytabletag” description = “Racing Results”>
<accesskey xpath = “xpath specification” description=”Racing Results”>.

In addition, specific bindings can be reserved for standard navigation actions such as, but not limited to giving focus to a particular document's banner, navigation bar, footer or header. Common navigation actions such as “forward” and “back” may also be associated with these reserved access keys. An application developer or portal designer can then map reserved access keys to browser 118 equivalents without knowing the particular key combinations on the browser 118 necessary for the particular actions. Thus, the claimed subject matter enables the developer and/or designer to provide consistent key navigation across a portal or multiple documents. This feature also enables the creation of genre-specific navigation shortcuts. In other words, common navigation features are based upon a specific genre associated with a particular document or portal. The specification of navigation short cuts corresponding to specific genres of applications or portals is described in detail below in conjunction with FIG. 7.

During a “Store Binding” block 218, process 200 stores the binding in memory of computer 102 such as, but not limited to, random access memory (RAM) (not shown) or data storage 112 (FIG. 1). In conjunction with the binding, process 200 stores information associated with the binding, including but not limited to, the associated function, document or web page. The operation of these bindings once established by process 200 is explained in more detail below in conjunction with FIG. 5. Process 200 then returns to block 208 during which processing continues as described above.

If process 200 determines there are no more application functions to be assigned to access keys during block 208 or determines there are no more unassigned access keys and duplicates are not permitted during block 220, control proceeds to a “Display Bindings” block 222. During block 222, process 200 displays the available key sequences, associated actions and corresponding descriptions, as exemplified and explained below in conjunction with window 260 of FIG. 6. Once the assigned bindings are displayed, control proceeds to an “End Setup IK” block 229 in which process 200 is complete.

In addition to displaying the bindings each time an application is initiated, the application provides means for the user to initiate the display after initiation. In the alternative, the bindings are only displayed in response to a request from the user and not at application initiation.

FIG. 5 is a flowchart of an exemplary Execute Input key (IK) process 240 associated with the claimed subject matter. Like process 200, process 240 is part of an OS, a browser or some another process. In the following example, process 240 is executed in conjunction with a web browser.

Process 240 starts in a “Begin Execute IK Process” block and proceeds immediately to an “Open Page” block 244 during which a web browser, e.g. browser 118 (FIG. 1), opens a page for display. During a “Retrieve Binding(s)” block 246, process 240 retrieves the information about access keys, functions and corresponding descriptions generated by process 200, explained above in conjunction with FIG. 4. The retrieved information is typically stored in a cache memory (not shown) of, in this example, computer 102 (FIG. 1). It should be noted that the information retrieved and cached is not necessarily static. A “Modify Bindings” process (not shown) provides a means for a user to dynamically reassign the bindings.

During a “Receive Input” block 248, process 240 detects input on the corresponding device, which on computer 102 may take the form of a series of keystrokes entered on keyboard 106 (FIGS. 1 and 2). As explained above in conjunction with FIG. 4, it should be understood that the input received during block 248 depends upon the particular device and corresponding configuration that implement the claimed subject matter.

During an “Input Assigned?” block 250, process determines whether of not the input received during block 248 corresponds to input that was assigned a binding during block 216 (FIG. 4) according to the information retrieved during block 246. If not, process 240 returns to block 248 to receive more input. If in block 250, process 240 determines that the input received in block 248 corresponds to a particular binding, control proceeds to a “Multiple Bindings?” block 252, during which process 240 determines whether or not there are in fact multiple assignments associated with the input received during block 248.

It should be noted that that may be more than one binding for a particular input, as explained above in conjunction with Dups Allowed? block 220 (FIG. 4). If not, process 200 proceeds to an “Execute Action” block 256 during which, in this example, computer 102 executes the function, or action, associated with the input received in block 248 and the associated binding retrieved in block 246. Once the action is executed control returns to Receive Input block 248 and processing continues as described above.

If in block 252, process 240 determines that there are duplicate bindings associated with the input received during block 248, then control proceeds to a “Determine Context” block 254 during which process 200 associates the appropriate binding to the input based upon the current application that is executing or has focus. In the alternative, duplicate bindings could be associated with a particular input on a cyclic, or “round robin,” basis, i.e. a particular input cycles through the multiple assignments in turn. Once a binding has been associated with the input received in block 248, process 240 proceeds to Execute Action block 256 and processing continues as explained above.

Finally, process 240 is halted by means of an interrupt 262, which passes control to an “End Associate IK Process” block 269 in which process 240 is complete. Interrupt 262 is typically generated when the OS, browser, application, etc. of which process 240 is a part is itself halted. During nominal operation, process 240 continuously loops through the blocks 248, 250, 252, 245 and 256, processing input sequences as a user generates them.

FIG. 6 is application window 160 described above in conjunction with FIG. 3 showing a Hot Key Assignment List 230 corresponding to the displayed application, i.e. app_{—}1 114 (FIG. 1). As illustrated above in conjunction with FIG. 3, window 160 includes title bar 162, window control buttons 164, menu items 166, toolbar buttons 168, title bar 172, horizontal slider bar 174 and vertical slider bar 176. Further, App_{—}1 window 170 is illustrated in the main area of app_{—}1 display 160.

Hot key Assignment list 280 is displayed in window 170 when app_{—}1 114 is first initiated. The initiation may be generated within a graphical user interface (GUI) of the OS or within browser 118, depending upon the particular configuration of computer 102 (FIG. 1) and the claimed subject matter. The information displayed in list 280 is based upon the functions and associated bindings stored in data storage 112 (FIG. 1) by Setup IK process 200 (FIG. 4). The display of list 280 in window 170 corresponds to Display Bindings block 222 (FIG. 4) of process 200.

List 280 includes two (2) columns: a Hot Key column 282 and an Action column 284. Hot Key column 282 displays the various input sequences that have been associated with specific access key bindings. Action column 284 displays the particular function action associated with the corresponding input sequence. Of course, additional information may be provided in list 280 or another column, e.g. more detail descriptions of the particular actions provided in column 284.

In this example, there are duplicates in column 282, meaning a particular input sequence is used for more than one function. For example, the key sequence “Alt-J” is employed to initiate a change of focus to tool bar buttons 168 and to a Navigation bar (not shown) associated with 114. In this example, multiple presses of Alt-J would cycle through focus on Tool bar 168 and a display of the Navigation menu.

List 280 is displayed when app_{—}1 114 is first executed. Input/access key bindings may be defined once and stored in a configuration file for each of applications 114 and 118. Each time one of applications 114 or 118 is initiated, list 280 is displayed with currently defined information, either via an execution of process 200 or, in the alternative, from information from the configuration file. A checkbox 286 enables the user to disable the display of list 280 upon execution of app_{—}1 114, for example if the user is already familiar with the particular bindings. App_{—}1 114 also includes means to display list 280 any time app_{—}1 114 is executing. Finally a “Continue” button 288 enables the user to terminate the display of list 280 and continue with the functionality of, in this case, app_{—}1 114.

FIG. 7 is a flowchart of an exemplary Setup Genre Keys (GK)” process 300 for setting up a genre specific implementation of the claimed subject matter on a computing device such as, but not limited to, desktop computer 102 (FIG. 1). Process 300 is explained with respect to a hypothetical stock trading program (not shown), which is, in the following example, displayed on display 110 via browser 118 (FIG. 1) and employs information contained in doc_{—}1 (FIG. 1). It should be noted that, as explained above, there are any number of possible genres such as, but not limited to, banking, health care, finance, weather, news, and so on.

Process 300 illustrates an embodiment that incorporates elements of process 200 (FIG. 4) and process 240 into a single process that is executed when an application incorporating the claimed subject matter retrieves a particular document of web page for the first time. Certain elements of process 300 perform essentially the same services as corresponding elements of process 200 and so, for the sake of simplicity, only those blocks of process 300 that differ substantially from the corresponding blocks of process 200 are described. Specifically, a “Prioritize Functions” block 306 corresponds to block 206; a “More Functions?” block 308 corresponds to block 208; a “Get Next Function” block 310 corresponds to block 210; a “Free Binding?” block 312 corresponds to block 212; a “Request Binding” block 314 corresponds to block 214; an “Assign Binding” block 316 corresponds to block 216, a “Store Bindings” block 318 corresponds to block 218, and a “Duplicates (“Dups”) Allowed?” block 320 corresponds to block 220.

Process 300 starts in a “Begin Setup Genre Keys (GK)” block 302 and control proceeds immediately to an “Open Page” block 304. As during open page block 204 (FIG. 5) of process 240, during open page block 304, process 300, via a device such as browser 118 (FIG. 1), opens a document or page for display. In this example, the device is browser 118 and the page displayed corresponds to doc_{—}1 116. During a “Retrieve Genre Info” block 322, process 300 determines what type of file that doc_{—}1 116 is by accessing tag_{—}1 117 (FIG. 1). Tag_{—}1 117 includes information relating to a genre that doc_{—}1 116 pertains so that process 300 can assign genre-specific navigation keys to doc_{—}1 116.

During a “Retreive Functions” block 324, information about specific functions, stored in conjunction with the application that displays doc_{—}1 116 or, in this example, browser 118, corresponding to the genre determined during block 322 are retrieved. Examples of functionality that might be assigned navigation shortcuts in a finance genre include stocks to watch, an account balance, various stock trading activities and displays of major stock indices. Other genres would include other functionality that is mapped to the available bindings. The following code segments are examples that may be included in browser 118 to define bindings corresponding to particular genres. Code to define an access key is as follows:
<element accesskey=“maincontent”>
In the example above, a standard accesskey is set on an element but “maincontent” is not particular to a genre. In the following example, a standard access key is defined in the head of html content by referencing an element's ID:
<accesskey id=“mymaincontent” purpose=“maincontent”>

An example of a code segment that defines a genre corresponding to a part of a document, i.e. a <div>, is as follows:

<body genre=”finance”>
<div accesskey=”Stocks to Watch”>
...
<div>
<div genre=”weather”>
<table accesskey=”maincontent”>...</table>.

In other words, genres are defined based upon the context scope of a particular document or part of a document. This enables multiple uses for any particular access key, with any particular use defines by the context in which the access key is executed.

As illustrated in the example above, a document may have more than one assigned genre. For example, a particular document may display HTML frames and iframes. In one embodiment, the parent document assigns all of its access keys and then child documents assign the keys that remain. In other words, documents assign their input devices in a depth-first order.

Once the genre has been determined during block 322 and the functions corresponding to the genre have been retrieved during block 324, process 300 proceeds to Prioritize Functions block 306, which, as mentioned above, functions in a manner similar to block 206. The remainder of process 300 executes like process 200 with corresponding blocks performing similar functions.

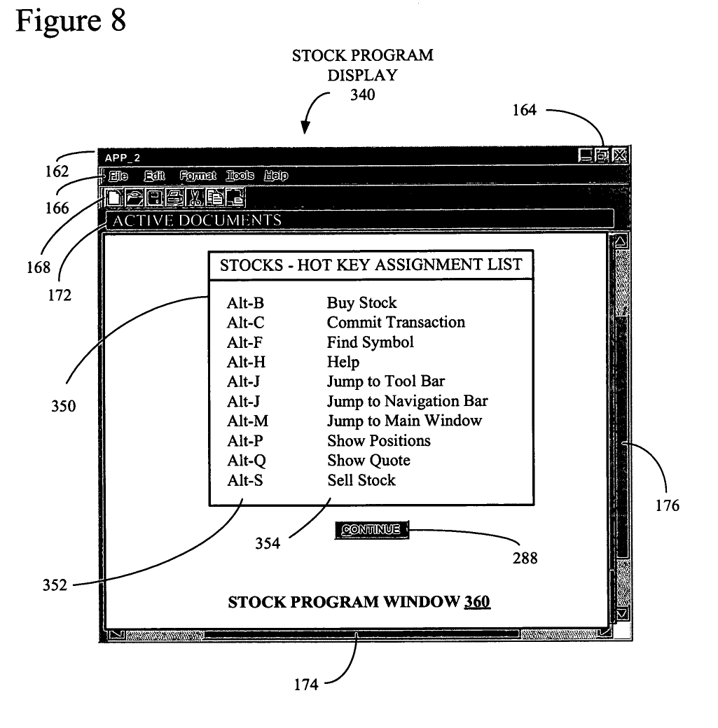

It should be noted that in this example, process 300 does not include a block that corresponds to Display Bindings block 222 (FIG. 4). Rather than automatically displaying access key binding assignments upon completion of process 300, bindings (see FIG. 8) are provided upon an explicit action by the user during operational process 240. Finally, process 300 proceeds to an “End Setup GK” block 329 in which process 300 is complete.

FIG. 8 illustrates a stock program application window 360 within a stock program display 340 showing a Hot Key Assignment List 350 corresponding to a stock program application, which in this example is a program for facilitating the trading of stocks and bonds. Like window 160 (FIG. 6), window 360 includes a title bar 162, window control buttons 164, menu items 166, toolbar buttons 168, title bar 172, horizontal slider bar 174 and vertical slider bar 176.

A hot key Assignment list 350 is displayed in window 360 when the corresponding stock program is executing and the user initiates the display via some defined user interface (not shown). The initiating user interface is typically within a GUI of the OS or within browser 118, depending upon the particular configuration of computer 102 (FIG. 1) and the claimed subject matter. The information displayed in list 350 is based upon the functions corresponding to the genre and associated bindings stored in data storage 112 (FIG. 1) by Setup GK process 300 (FIG. 7).

List 350 includes two (2) columns: a Hot Key column 352 and an Action column 354. Hot Key column 352 displays the various input sequences that have been associated with specific access key bindings. Action column 354 describes the particular function action associated with the corresponding input sequence. Of course, more information than shown in FIG. 8 may be provided.

In this example, there are duplicates in column 352, meaning a particular input sequence is used for more than one function. For example, the key sequence “Alt-J” is employed to initiate a change of focus to tool bar buttons 168 and to a Navigation bar (not shown) associated with the stock program. In this example, multiple presses of Alt-J would cycle through focus on tool bar 168 and a display of the navigation menu.

List 350 may also be displayed when the corresponding stock program is first executed. Input/access key bindings may be defined once and stored in a configuration file. Finally a “Continue” button 288 enables the user to terminate the display of list 350 and continue with the functionality of, in this case, the corresponding stock program.

Typically, a user may have multiple applications running on a system such as computer system 102 (FIG. 1). The claimed subject matter can be configured to notify the user as the computing context changes via mechanisms such as an audio alert or an on-screen display. In other words, as a user changes focus from an application or document in one genre with genre specific bindings to a second application or document in a second genre, the user is notified of the change and thus made aware of the relevant navigation shortcut changes. In this manner, a device may reuse shortcuts while navigating to various sites.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for assigning navigation shortcuts corresponding to an application, comprising:
reserving a plurality of access keys corresponding to a device that executes an application, wherein particular access keys of the plurality of access keys are associated with standardized navigation functions;
opening a document of a plurality of documents corresponding to the application;
receiving a plurality of functions and corresponding descriptions;
dynamically assigning each function of the plurality of functions to an access key of the plurality of access keys such that the standardized navigation functions are consistent across the plurality of documents; and
providing information related to the access keys, functions and descriptions.

2. The method of claim 1, wherein the plurality of documents is associated with a particular genre and the standardized navigation functions correspond to the particular genre.

3. The method of claim 1, wherein a document of the plurality of documents is associated with multiple genres and the standardization navigation functions are assigned within each genre of the multiple genres.

4. The method of claim 1, wherein multiple functions are assigned to a particular access key and functionality is cycled in turn through the corresponding functions upon repeated activations of the particular access key.

5. The method of claim 1, wherein at least one of the access keys correspond to one or more keystrokes on a keyboard.

6. The method of claim 1, wherein at least one of the access keys correspond to a function key of a plurality of function keys.

7. The method of claim 1, wherein the device is a web browser and the document associated with the application is a web page.

8. A system of navigation shortcuts corresponding to an application, comprising:
a plurality of access keys corresponding to a device that executes an application, wherein particular access keys of the plurality of access keys are associated with standardized navigation functions;
a plurality of documents corresponding to the application;
receiving a plurality of functions and corresponding descriptions;
logic for dynamically assigning each function of the plurality of functions to an access key of the plurality of access keys such that the standardized navigation functions are consistent across the plurality of documents; and
logic for providing information related to the access keys, functions and descriptions.

9. The system of claim 8, wherein the plurality of documents is associated with a particular genre and the standardized navigation functions correspond to the particular genre.

10. The system of claim 8, wherein a document of the plurality of documents is associated with multiple genres and the standardization navigation functions are assigned within each genre of the multiple genres.

11. The system of claim 8, wherein multiple functions are assigned to a particular access key and functionality and further comprising logic for cycling in turn through the corresponding functions upon repeated activations of the particular access key.

12. The system of claim 8, wherein at least one of the access keys correspond to one or more keystrokes on a keyboard.

13. The system of claim 8, wherein at least one of the access keys correspond to a function key of a plurality of function keys.

14. The system of claim 8, wherein the device is a web browser and the document associated with the application is a web page.

15. A computer programming product for assigning navigation shortcuts corresponding to an application, comprising:
a memory;
logic, stored on the memory, for reserving a plurality of access keys corresponding to a device that executes an application, wherein particular access keys of the plurality of access keys are associated with standardized navigation functions;
logic, stored on the memory, for opening a document of a plurality of documents corresponding to the application;
logic, stored on the memory, for receiving a plurality of functions and corresponding descriptions;
logic, stored on the memory, for dynamically assigning each function of the plurality of functions to an access key of the plurality of access keys such that the standardized navigation functions are consistent across the plurality of documents; and
logic, stored on the memory, for providing information related to the access keys, functions and descriptions.

16. The computer programming product of claim 15, wherein the plurality of documents is associated with a particular genre and the standardized navigation functions correspond to the particular genre.

17. The computer programming product of claim 15, wherein a document of the plurality of documents is associated with multiple genres and the standardization navigation functions are assigned within each genre of the multiple genres.

18. The computer programming product of claim 15, wherein multiple functions are assigned to a particular access key and functionality is cycled in turn through the corresponding functions upon repeated activations of the particular access key.

19. The computer programming product of claim 15, wherein at least one of the access keys correspond to one or more keystrokes on a keyboard.

20. The computer programming product of claim 15, wherein the device is a web browser and the document associated with the application is a web page.
